(19) United States
(12) Patent Application Publication
(10) Pub. No.: US 2007/0212263 A1
(43) Pub. Date: Sep. 13, 2007

(54) Micro Thermoelectric Type Gas Sensor

(75) Inventors: Woosuck Shin, Aichi (JP); Noriya Izu, Aichi (JP); Ichiro Matsubara, Aichi (JP); Norimitsu Murayama, Aichi (JP); Kazuki Tajima, Aichi (JP); Fabin Qiu, Jilin (CN); Zhihui Zhao, Jilin (CN)

Correspondence Address: OBLON, SPIVAK, MCCLELLAND, MAIER & NEUSTADT, P.C., 1940 DUKE STREET, ALEXANDRIA, VA, 22314, US

(73) Assignee: NAT. INST. OF ADV. INDUSTRIAL SCI. AND TECH., CHIYODA-KU (JP)

(21) Appl. No.: 10/593,255

(22) PCT Filed: Mar. 16, 2005
(86) PCT No.: PCT/JP05/04657

§ 371 Date: May 9, 2007

(30) Foreign Application Priority Data
Mar. 17, 2004 (JP) 2004-075982
Jul. 7, 2004 (JP) 2004-201213
Jan. 31, 2005 (JP) 2005-024115
Mar. 10, 2005 (JP) 2005-067297

(51) Int. Cl. G01N 27/16

(52) U.S. Cl. 422/95

(57) ABSTRACT

The present invention provides a micro thermoelectric gas sensor having a thermoelectric conversion section, a microheater, a catalyst layer formed on the microheater and to be heated by the microheater, which acts as a catalyst for catalytic combustion of a combustible gas, and a sensor detection section with an electrode pattern therefore formed on a membrane of a predetermined thickness, and a method for forming a micropattern of a functional material of a catalyst or resistor in a predetermined position on a substrate in a state in which the microstructure of the functional material remains controlled.

### TECHNICAL FIELD

The present invention relates to a thermoelectric gas sensor having a microelement structure, and more particularly to an inexpensive micro gas sensor of a contact combustion type that has a simple configuration and can differentiate gas species in a combustible gas mixture with a high accuracy. The present invention provides a micro thermoelectric gas sensor of a novel type that has a low electric power consumption and enables highly sensitive concentration measurements and a high-speed response.

The present invention also relates to a technology for forming three-dimensional micropatterns of functional materials, and more particularly to a method for forming a micropattern of a catalyst or resistor on a substrate of a gas sensor that detects the heat generated by a catalytic reaction of a combustible gas and a catalyst material as a detection signal, or on a substrate of a thermoelectric power generator that converts the heat into electricity, and also to a gas sensor and a thermoelectric power generator having a micropattern formed by this method.

The present invention provides a micropattern formation method for forming a micropattern of a functional material on a substrate of a gas sensor or a thermoelectric power generator, wherein the micropattern can be formed in a state where the predetermined controlled microstructure is maintained, and also provides a product employing such method. The present invention is useful as a technology that can be employed in a variety of fields, for example, in applications to forming an electrically conductive wiring pattern by patterning an electrically conductive material and to gas sensors produced by forming a pattern of a catalytic material.

### BACKGROUND ART

In order to ensure stable operation of a gas sensor, the sensor element has to be heated to a high temperature. The conventional heaters designed for this purpose have been formed by printing, e.g., a platinum resistor in the form of a thick film with a thickness of several tens of micron on a ceramic substrate. Such sensor elements are difficult to miniaturize. Yet another problem is that because the entire ceramic substrate is heated, the sensor has a poor response of several minutes to temperature increase and a high power consumption of several watts. Microheaters that are produced by microprocessing technology using, e.g., a technique of anisotropic etching of silicon have been widely used in recent years in sensor elements, for example, of gas sensors, infrared radiation sensors, and flow meters.

For example, typical semiconductor gas sensors use a sensitive film with an electric resistance changing according to the gas concentration, but the sensitive films are usually not activated unless heated to a temperature of 200° C. or higher. For this reason, the sensor responsiveness depends on the heater performance. Employing a microheater with a greatly reduced thermal capacity in such gas sensor makes it possible to realize a gas sensor with a response of several tens of millisecond; such technology is described in references as typical commentaries (Microsensors MEMS and Smart Devices, J. W. Gardner, p. 280-300, 2001 and John Wiley & Sons Ltd., Chichester, England, ISBN 0-471-86109-X).

A method of directly coating and forming a functional film comprising a catalyst-added metal oxide on a membrane made from an insulating film such as silicon nitride formed on a semiconductor substrate is the most typical of methods for forming functional films on semiconductor microsensors (Japanese Patent Application Laid-open No. 8-278274).

The technology of producing gas sensors using micrometers has a history of about 10 years. If a microheater is produced on a substrate by a usual method, the thermal energy generated thereby is simply released to the substrate. For this reason, a technology using the so-called MEMS processing that can shield the heat and minimize thermal capacity has been widely used. Thus, the most typical is the so-called three-stage process in which element sections such as a microheater section and an electrode section are produced on one surface of a silicon wafer, then a membrane structure is produced by chemically etching the rear surface, and finally a portion for participating in a reaction with gas is formed on the element. Micro gas sensors using such micorheaters have been reported to be generally classified into those of a semiconductor system and those of a contact combustion system.

With regard to semiconductor gas sensors using the microheater technology, a large number of reports are published, but materials for gas detection element sections, for example, oxide semiconductors such as SnOx additionally containing a noble metal are very difficult to produce with high reliability. The problem arising when high-temperature firing is used to produce an oxide semiconductor for gas detection with good stability is that characteristics of microheater and micropatterned wiring are degraded.

As a gas sensor of a contact combustion system using the microheater technology, for example, a gas sensor of a contact combustion system is described in Nikkei Electronics, p. 117-118, November 2003. In this gas sensor of a contact combustion system, a gas detection element and a compensation element are separately provided on two membranes having the predetermined thickness on a silicon substrate, and a combustion gas is detected and quantitatively determined by detecting the combustion heat generated when the combustion gas is combusted at the gas detection element section by the variation of resistance of platinum or the like. However, in gas detection devices using the electric resistance variation, gases with a low concentration cannot be detected, unless the microheater temperature is maintained with a high accuracy to increase the detection accuracy.

This is because the variation of resistance with respect to small changes in temperature is not that large. Furthermore, because a bridge circuit incorporating a reference (corresponds to a comparative element or a compensation element) is used, the structure of the gas detection device becomes complex. Moreover, when gas species of a combustible gas comprising a gas mixture of hydrogen, carbon monoxide, methane, and the like are differentiated, it is difficult to select only a specific gas from the gas mixture. For this reason, sensor structures are provided for detecting selectively a number of gas types, the signals from those sensor structures have to be information processed, the configuration becomes complex, and the cost is high.

As another example of a gas sensor of a contact combustion type using the microheater technology, a gas sensor of a catalytic combustion system is exemplified (Japanese Patent Application Laid-open 2001-99801). In the gas sensor of this type, a low-temperature section is formed on a substrate, rather than on a membrane, and the resultant problem is that the increase in temperature of the high-temperature section is not stable and the response rate is low. Furthermore, with regard to a structure providing gas selectivity, individual combustible gases are difficult to distribute and determine quantitatively, because a spatial control of catalyst temperature in the structure is extremely difficult.

Moreover, the sensor of this type has a complex structure, and therefore it is difficult to manufacture it, and signal processing is so complex that requires a large number of peripheral circuits. As for the structure generating the difference in temperature, since the low-temperature section is formed on the substrate rather than on the membrane, a larger sensor voltage output can be obtained for the combustible gas, but if the substrate temperature changes, e.g., due to changes in the ambient temperature, the temperature serving as a reference point changes. In order to increase the output, a thermoelectric conversion material has to be used more aggressively for the so-called thermopile member in this method than in the above-described structure. Thus, the conventional sensors have a large number of problems that have to be resolved in order to attain a low power consumption, high-sensitivity concentration measurements, and high responsiveness, and there is a strong demand for the development of novel technology capable of resolving those problems in the pertinent field of technology.

On the other hand, a large number of methods have been suggested for producing micropatterns of functional materials by a sol-gel coating method or producing a thin film on a substrate by a thin-film process and leaving the necessary portion by using a semiconductor process. The so-called photolithography method, which is a pattern formation technique used in those methods, is a method for forming a micropattern by local exposure using a mask. However, there are also techniques for forming micropatterns that use no masks, examples thereof being screen printing and an ink jet method.

Patterns of functional materials have been conventionally formed by using a method by which a paste comprising a powder-shaped particles as the main component is coated on a substrate by a screen printing method, dried, and then fired. Examples of such functional materials include electrically conductive wirings, gas sensor materials that are semiconductor ceramics, members in which elements are bonded to a substrate after firing, fluorescent materials for plasma display panels, and the like. An ink jet method represents a novel technology that has recently started finding use as a micropattern formation method.

However, as the miniaturization of patterns advanced, it became difficult to perform coating with high accuracy due to expansion-shrinkage and alignment errors of screen masks. Screens for micropatterns are difficult to produce and problems associated with endurance easily arise in mass production. Furthermore, since patterning is difficult if a viscosity is low, a limitation is placed on paste viscosity. A very narrow usable viscosity range of about 5 to 50 mPa·s is typical for the ink jet method. If a paste comprising a powdered substance is obtained, the particle size is strictly limited and the application range is narrow. Moreover, with the screen printing method or ink jet method, a pattern can be formed on a plane surface, but patterns are difficult to form on three-dimensional structures.

For example, when irregularities are present on the substrate surface, a micropattern of a function material is difficult to form in the specific portions on the bottom of valleys by the screen printing, ink-jet printing, and thin film vapor deposition method. Even in a system in which part of the substrate is etched, a catalyst thin film is formed as a micropattern in the specific portions on the bottom of valleys, a difference in temperature is produced by heat generation from the micropattern, and an electric power is generated by a thermoelectric conversion material; since a thin film vapor deposition method is used, the micropattern is difficult to form with high accuracy on the bottom of valleys. In addition, when a catalyst is formed by thin film vapor deposition, a high-performance catalyst pattern using nanoparticles as a starting material is difficult to form and a catalyst pattern with poor performance is easily obtained. The resultant problem is that heating with a heater is necessary to induce a catalyst reaction.

On the other hand, an attempt has been made to produce a micropattern by employing a dispenser technology. Dispensers have been used in prior art for forming patterns by coating adhesives of various types including epoxy adhesives and electrically conductive adhesives or various lubricants such as greases and oils. The dispensers have recently been also employed for coating a fluorescent substance in the manufacture of display panels (Japanese Patent Application Laid-open No. 2003-317618). The formation of micropatterns by using a dispenser to coat a dielectric material has also been reported (J. E. Smay, Langmuir 2002, 18, 5429). However, in those cases, a dispenser was simply used as a means for coating a material.

Thus, though there are specific examples of using dispensers as means for coating the materials in the field of microprocessing, the dispensers have not been considered at all as a micropattern formation technique that makes it possible to design and prepare a material demonstrating a specific functionality based on a three-dimensional microstructure of the material by controlling the predetermined microstructure including the shape and distribution state of particles that are the main component of a starting material paste of the functional material, and also to perform the micropatterning of the material, while maintaining the controlled predetermined microstructure thereof.

### DISCLOSURE OF THE INVENTION

With the foregoing in view, the inventors have conducted a comprehensive study aimed at the development of a novel technology that can solve the above-described problems inherent to the conventional technology and produce a microelement structure of a thermoelectric gas sensor. The results obtained have demonstrated that a gas sensor element that has a low power consumption and a high-speed response and is suitable for concentration measurements with high sensitivity can be realized by forming a high-temperature section and a low-temperature section of a thermoelectric thin film on the same substrate. Subsequent research led to the creation of the present invention. It is an object of the first aspect of the present invention to provide a thermoelectric gas sensor with a microelement structure that has a low power consumption and enables concentration measurements with high sensitivity and high-speed response.

Furthermore, in view of the above-described drawbacks of the conventional technology, the inventors have also conducted a comprehensive study with the object of developing a technology for forming a fine pattern in a state in which a predetermined microstructure including the composition, particle shape, and distribution of a functional material that was designed and prepared in advance for the formation on a substrate in a gas sensor and thermoelectric generator can be maintained in a controlled state. The results of the study demonstrated that the desired object can be attained by employing a specific configuration using a dispenser. This finding led to the creation of the present invention. It is an object of the second aspect of the present invention to provide a method for forming a three-dimensional fine pattern of a functional material as a starting material of a resistor or a catalyst on a substrate of a gas sensor or thermoelectric generator and a also to provide a gas sensor or thermoelectric generator comprising as a constituent element a fine pattern formed by using this method.

The first aspect for carrying out the present invention will be described below in greater detail.

In the micro thermoelectric gas sensor in accordance with the present invention, a membrane for heat shielding is formed on a substrate, a catalyst material that induces a catalytic reaction in contact with a gas to be detected, a thermoelectric conversion material film that converts a local temperature difference produced by heat generation caused by the reaction into a voltage signal, and a microheater for temperature control for facilitating stable gas detection of the gas sensor are formed on the membrane, and a high-temperature section and a low-temperature section of a thermoelectric thin film are formed on the same membrane. In this thermoelectric gas sensor, by converting the temperature difference caused by heat generation by the catalyst into a voltage based on a thermoelectric conversion principle that can be detected with high sensitivity, the drift is eliminated, by contrast with gas detectors using a resistance variation, and, therefore, a characteristic that especially excels in detecting gases at low concentration can be demonstrated.

It is important that in the gas detection sensor in accordance with the present invention, only the catalyst section can be heated and temperature controlled with a microheater unit in order to facilitate stable gas detection of the gas sensor, in particular, to obtain a temperature of the catalyst section, in which the reaction with the gas proceeds, such that the catalytic reaction proceeds with high stability. As a result, the sensor element can have high responsiveness and a low electric power consumption. Furthermore, by employing a structure in which the catalyst section and microheater section are carried on a membrane with a thickness of 1 μm or less that is formed for heat shielding, for example, on a silicon substrate and producing the heater in the form of a thin film, the heat capacity of the heater section is reduced and the heater is spatially separated from the silicon substrate, whereby the heat transfer to the silicon substrate can be reduced to a minimum. As a result, the responsiveness of the sensor element can be increased and the electric power consumption thereof can be decreased.

In accordance with the present invention, for example, the technology of anisotropic etching of a silicon substrate with an alkali solution can be used to produce a membrane. More specifically, with such technology, anisotropic etching of a silicon substrate is conducted by using a phenomenon of an etching rate of the (111) plane of a silicon crystal being much lower than that of other main planes (100) and (110), and such technology has been used in the so-called microsystem research. Because a sensor with a low electric power consumption and a high response rate can be obtained by actually miniaturizing the drive zone, this technology was applied to flow rate sensors of gases. In accordance with the present invention, any substrate material can be used similarly to silicon, provided that the effectiveness thereof is the same.

The simultaneous formation of the thermoelectric thin film and the microheater structure is a specific feature of the micro thermoelectric hydrogen sensor that is significantly different from the structure of typical micro gas sensors. Because a membrane formed for heat shielding cracks easily from a size of about 1 mm², a large membrane is very difficult to produce. A micro thermoelectric hydrogen sensor is produced by incorporating a heater pattern, a thermoelectric pattern, and electrodes thereof in this surface area.

In particular, in the field of detecting temperature variations, the detection efficiency can be increased by using a material with a high thermoelectric performance to convert a local temperature difference into electricity. In accordance with the present invention, gas detection can be performed with high sensitivity by employing, for example, a SiGe semiconductor thin-film material. Furthermore, an element can be produced by a simpler process by forming a thermoelectric pattern on one side of a thermocouple, forming a heater and a thermoelectric thin-film pattern on the same surface and greatly reducing an etching window for an insulating film and an electrode lead-out wire. Alternatively, when serial circuits of thermocouples are piled, a large voltage output can be obtained from a smaller temperature difference, and in this case the peripheral circuitry can be greatly simplified.

By producing a plurality of membranes, providing a low-temperature section on a membrane other than that of a high-temperature section and controlling the temperature with a microheater so that the low-temperature section has the same temperature as the high-temperature section, the temperature difference caused by the catalytic reaction can be prevented from being affected by changes in the ambient temperature. Furthermore, with this structure, the offset voltage can be reduced to a minimum.

By changing the type of the catalyst material of the sensor surface and using either a single element or a combination of elements of different types, a detection gas selectivity can be provided. As a result, for example, hydrogen, carbon monoxide, methane, and propane can be easily and accurately differentiated. The present invention is very effective for differentiating those mixed gases and quantitatively assaying them.

A microelement has to be designed by considering at the same time a process design involving the sequential implementation of several processes, rather than a flat wiring diagram viewed from the top of the element. Forming a thermoelectric thin film at the same time as the microheater structure is a specific feature of the micro thermoelectric hydrogen sensor that is significantly different from the structure of the typical micro gas sensor. The element production process will be considered below.

Taking into account the high-temperature heat treatment of the thermoelectric thin film, in accordance with the present invention, for example, a thermoelectric thin-film pattern is first manufactured, then a platinum heater pattern is produced, and finally a gold wiring pattern is formed. When SiGe is used as the thermoelectric thin film, the crystallinity thereof is increased and thermoelectric performance is improved by conducting heat treatment up to a high temperature after sputter deposition. If a platinum thin film used as a heater is heat treated at a high temperature, the pattern can be destroyed, causing disconnection. Therefore, the initial step in the process sequence is the formation of a SiGe pattern.

In accordance with the present invention, for example, after a platinum heater has been formed, a SiO₂ oxide film is formed as an insulating film by using a plasma-enhanced CVD (PECVD), a window for an electrode contact section is opened, and then a gold wiring pattern is produced. The heater uses, for example, a titanium film as an interlayer to increase the bonding strength thereof to the oxide film. The heater is laminated in a state of contact with the oxide film and titanium, an oxide film is laminated in a state of thermal contact on the heater, and a catalyst layer is formed in a state of thermal contact on the oxide film.

At the last stage of the process, a membrane is formed, for example, by wet etching of the rear surface of a silicon substrate. In this case, a silicon processing technology using an aqueous solution of strong alkali can be used.

After the wet etching, for example, a platinum catalyst is formed by sputter deposition. The reason for forming the catalyst section at the final stage of the process after the wet etching is to minimize the effect of the processes such as high-temperature heat treatment, photolithography, and etching.

The present invention provides a gas detection sensor of a new type that can differentiate gas species in a combustible gas mixture and enables integration on a silicon chip, high sensitivity, and high-speed response with a simple configuration. The present invention makes it possible to obtain a microelement structure of a thermoelectric hydrogen sensor, and because such novel micro thermoelectric hydrogen sensor employs a thermoelectric conversion principle, by contrast with the above-described gas sensors of a contact combustion type that are equipped with a microheater and use a variation of electric resistance, the advantage of the novel sensor is in that a stable output can be obtained without a drift.

Furthermore, the micro thermoelectric hydrogen sensor in accordance with the present invention differs from the gas sensor of a catalyst combustion type (described in Japanese Patent Application Laid-open No. 2001-99801) in a manner of providing a catalyst temperature with a microheater and also in a manner of picking up the temperature difference, whereby different performance is demonstrated. The microheater in accordance with the present invention enables fine control of catalyst temperature, thereby providing the catalyst itself with gas selectivity and thus providing a gas sensor in which a higher selectivity is obtained with a simple element. Furthermore, by forming a high-temperature section and a low-temperature section of a thermoelectric thin film on the same membrane, a gas sensor can be realized that enables concentration measurements with high sensitivity and high-speed response.

Explaining the sensor in greater detail, FIG. 4 shows a response characteristic of a voltage signal and a difference in temperature between the high-temperature section and low-temperature section in a thermoelectric gas sensor at room temperature. Because the voltage signal demonstrates a response identical to the variation of temperature difference, the response characteristic is clearly determined mainly by the variation of temperature difference of the front surface. The voltage signal (left ordinate) on the left side and temperature variation (right ordinate) in FIG. 4A immediately become flat in response to hydrogen gas, and concentration measurements can be conducted. This is different from temperature variations in the high-temperature section and low-temperature section in FIG. 4B.

When only the temperature of the high-temperature section rises and the temperature of the low-temperature section is fixed to the substrate temperature, that is, room temperature, then even if the difference in temperature between the high-temperature section and low-temperature section is the same, the variation becomes gradual as shown in FIG. 4B, and the response characteristic such as shown in FIG. 4A cannot be obtained (w. Shin, et al., “Li and Na-Doped NiO Thick Film for Thermoelectric Hydrogen Sensor”, Journal of Ceramic Society of Japan, 110 (11), pp. 995-998 (2002)).

The second aspect of the present invention will be described below in greater detail.

A method for forming a micropattern in accordance with the present invention is a method for forming a micropattern of a catalyst or resistor on a substrate of a gas sensor for detecting the heat generated by a catalytic reaction of a combustible gas and a catalyst material as a detection signal, or on a substrate of a thermoelectric generator that converts the heat into electricity, this method comprising the steps of designing and preparing a functional material serving as a starting material for the catalyst or resistor by controlling the predetermined microstructure thereof, applying the functional material serving as a starting material for the catalyst or resistor according to a predetermined pattern by discharging to a predetermined position on a substrate, while moving a dispenser three-dimensionally, and thereby forming a micropattern in a state where the microstructure including the shape and distribution state of particles that are the main component of the functional material remains controlled.

Examples of materials suitable for the catalyst or resistor in accordance with the present invention include crystalline oxides or oxides having a noble metal dispersed therein, such as alumina and tin oxide, but these examples are not limiting. The formation of a micropattern in a state where the microstructure including the shape and distribution state of particles that are the main component of the functional material remains controlled in accordance with the present invention means that a functional material having a predetermined microstructure, for example, composed of crystalline oxides or oxides having a noble metal dispersed therein and having a nanometer size of the particles is micro-patterned, while maintaining the microstructure thereof. Furthermore, discharging the catalyst or resistor, while moving a dispenser three-dimensionally, in accordance with the present invention, means that the starting material for the catalyst or resistor is selectively formed in a specific portion on a fine electrode or a membrane.

In accordance with the present invention, the formation of a catalyst member that is one of constituent components of the element that uses a local temperature difference generated in the element is as a signal source or electric power source is carried out by a method using a dispenser. Furthermore, the particle size of a paste serving as a starting material for the catalyst is selected at a nanometer level to improve the catalyst performance, and a fine pattern having the predetermined shape, structure and microstructure is formed by using such particles. In accordance with the present invention, specific features of the micropattern can be randomly designed according to the shape, structure, and application of the element.

When heat is generated by a catalytic reaction of a gas mixture of a combustible gas fuel and air, heat and light are generated. A local temperature difference generated by the heat of the combustion reaction can be converted into electric energy by using a thermoelectric conversion material. In accordance with the present invention, a gas sensor or thermoelectric generator of higher performance is provided by using a dispenser to form the catalyst. In accordance with the present invention, for example, in order to enhance the generation of temperature difference caused by a stable catalytic reaction, a structure is used in which the catalyst is placed on a membrane with a thickness of 1 μm or less on a silicon membrane, whereby the heat capacity of the element can be reduced, heat transfer to the substrate can be reduced to a minimum, and the responsiveness of the element can be improved.

In accordance with the present invention, a combustion heat thermoelectric device element or thermoelectric gas sensor can be provided which is a system for converting a local temperature difference generated by heat of the combustion reaction into electric energy by using a thermoelectric conversion material and for using this electric energy as a motion source. The development of portable electronic devices, miniature medical devices, and autonomous robot technology in recent years created a demand for utlrasmall energy sources of a several watt class as a replacement for lithium batteries. Because micro combustion heat thermoelectric devices have not drive units, by contract with microturbines and the like, it is desirable to develop an ultrasmall power generating system that is small, highly reliable and uses such micro combustion thermoelectric devices. In the case of gas sensors, it is desirable that thermoelectric gas sensors that have a small drift and simple electric circuits and enable gas detection at a high performance level be put to practical use.

In accordance with the present invention, a starting material paste is prepared such that when the paste pattern formed on the element surface is subjected to heat treatment and fired, the final catalyst structure becomes a composite comprising oxide nanoparticles and a noble metal with a size of several nanometers that is dispersed on the nanoparticle surface. Thus, the starting material composition for the catalyst and the microstructure thereof are designed and the starting material paste is prepared such that when the paste-like material is formed on the element surface and then subjected to heat treatment and fired, the final catalyst structure becomes a composite comprising oxide nanoparticles and a noble metal with a size of several nanometers that is dispersed on the nanoparticle surface. Examples of oxide nanoparticles include alumina, silica, and tin oxide, examples of noble metals include Pt, Pd, and Au, and an example of microstructure is a structure in which metal nanoparticles are dispersed in a predetermined dispersion state on the surface of oxide, but these examples are not limiting.

The catalyst is formed on a membrane with a low thermal conductivity so that the thermal energy generated from the catalyst is not transferred to the ambient space. In accordance with the present invention, the advantage of using the dispenser is that various needle diameters can be selected, thereby making it possible to produce easily a catalyst pattern of a complex shape such as a lattice, the pattern can be formed on a thin film with poor mechanical strength and wide-range applications that are not limited by the substrate shape are possible, and the room-temperature actuation of the device is enabled by the use of such catalyst of a new type.

Using the method in accordance with the present invention makes it possible to form a pattern of a complex shape even on an element surface having irregularities, as shown in FIG. 8. FIG. 9 illustrates schematically the formation of a catalyst pattern on top of a membrane. If the fuel gas flows in etched zones on the lower surface of the element, then the catalyst has to be formed on the lower surface of the membrane. In this case, the dispenser method enabling the formation of pattern shown in FIG. 8 apparently provides for best productivity. Applying finer and thinner lines makes it possible to form a catalyst pattern other than the above-described pattern. For example, overlapping the lines in a perpendicular fashion enables the formation of a lattice-like catalyst pattern. A line width can be reduced by decreasing the inner diameter of the nozzle and reducing the discharge amount.

With a micropattern formation method based on the conventional thin-film processing, screen printing, and ink jet printing, a micropattern is difficult to form in a state in which the microstructure, for example, including the shape and distribution state of the particles that are the main component of the functional material, is maintained. However, with the method in accordance with the present invention, a predetermined micropattern can be formed in a state in which the microstructure, for example, including the shape and distribution state of the particles that are the main component of the functional material, is maintained. For example, when a paste of a catalyst and an oxide prepared in advance by controlling a microstructure is used as a functional material, a predetermined micropattern can be formed in the form such that the microstructure is perfectly maintained.

The present invention makes it possible to attain the increase in functionality of the functional material and the increase in accuracy of the micropattern at the same time and is important as means for demonstrating the functionality of nanomaterials. In accordance with the present invention, a micropattern of a starting material of a functional material having a specific microstructure that was designed and prepared in advance is formed by maintaining the microstructure, a gas sensor that performs the detection by using the heat generated by a catalytic reaction as a detection signal or a thermopile for converting the heat into electricity can be produced with high accuracy.

Furthermore, in accordance with the present invention, when a catalyst powder or catalyst paste for use in the micropattern is prepared, for example, a metal chloride and an oxide powder are directly mixed with an organic dispersion material, a pattern is formed, and then heat treatment is conducted at a temperature from 150° C. to 300° C., whereby a pattern of a composite of metal ultrafine particles of a nanometer size can be formed. Usually, the problem is that metal chlorides remain unchanged unless heating is conducted up to a high temperature, and if the heating is conducted to a high temperature, ultrafine metal particles increase in size. In accordance with the present invention, for example, mixing and heating a chloride and an organic dispersion material, the chloride is reduced as ultrafine metal particles even at a low temperature of about 150° C., and particle growth can be prevented.

The applications in which pattern formation can be performed with a dispenser are not limited to catalysts. For example, the pattern formation method in accordance with the present invention can be also employed for forming a semiconductor material, for example, in a gas sensor for detecting changes in electric resistance of a semiconductor material as a detection signal by a surface reaction of a combustible gas and the semiconductor material. Within the framework of the conventional technology, physical methods such as sputter deposition or chemical methods such coating a sol-gel solution have been used for integrating oxide semiconductor materials on microelements. However, when such methods are used, crystallization does not proceed in a state of integration on the microelement. Therefore, the crystallization is eventually induced by heat treatment. In such a process, low-temperature heating is conducted within an extremely short interval to prevent an adverse effect on the microelement. For this reason, a semiconductor material with sufficient performance is very difficult to product.

Microelements using a ceramic catalyst are high-sensitivity sensor elements capable of detecting hydrogen gas with a low concentration, for example, of 0.5 ppm. However, when a low-concentration gas at a ppm level is detected with such microelement, the generated voltage thereof is about 1 microvolt which is extremely low for a signal voltage. With a simple electric circuitry, such signal voltage cannot be used because it is at level of noise and, therefore, complex circuits are required to reduce the noise.

By contrast, in accordance with the present invention, for example, a micro catalyst thermoelectric power generating element was produced by forming a catalyst micropattern by using a dispenser (FIG. 9, FIG. 10). This thermoelectric power generating element is a thermopile comprising thermocouples connected in series, and a higher voltage can be obtained. When compared with the sensor element comprising one thermocouple as shown in FIG. 11, this element is a thermopile comprising 20 thermocouples, and when such thermopile is applied to a sensor element, the spontaneous voltage signal thereof can be greatly increased.

From the standpoint of a thermoelectric conversion principle, because the voltage is simply increased according to the number of thermocouples, when 20 thermocouples are used, a voltage signal obtained is 20 times larger than that obtained in a thermoelectric element having one thermocouple. The same result was obtained in an actual test. In the case of a sensor element shown in FIG. 11, a voltage of 4 mV was generated from a temperature difference of about 40° C. (FIG. 13). In the case of a thermopile, a voltage of about 13.4 mV was generated from a temperature difference of about 3.2° C. (Table 1). Recalculating as a voltage per unit temperature difference, we obtain 0.1 mV/° C. and 4.2 mV/° C., respectively, and the voltage signal is, therefore, increased by a factor of several tens. The factor different from a theoretically estimated factor of 20 was obtained apparently due to an error in measuring the surface temperature.

With the present invention a thermopile pattern can be easily formed and gas concentration detection can be conducted with a higher sensitivity by using the thermopile pattern in a sensor element. In accordance with the present invention, because a semiconductor powder with high crystallinity can be directly formed as a fine pattern, the performance of gas sensor can be improved, for example, the response speed and detection sensitivity can be increased.

With the first aspect for carrying out the present invention the following effects are demonstrated.

(1) A thermoelectric gas sensor with a microelement structure can be provided.

(2) The catalyst temperature can be finely controlled with a microheater.

(3) As a result, the catalyst itself can be provided with gas selectivity,

(4) A gas sensor can be provided in which selectivity is increased with a simple element.

(5) Concentration measurements can be conducted with high-speed response and high sensitivity by forming the high-temperature section and low-temperature section of a thermoelectric thin film on the same membrane.

With the second aspect for carrying out the present invention the following effects are demonstrated.

(1) In accordance with the present invention, a fine pattern of a functional material to be reacted with a combustible gas can be formed so as to demonstrate the maximum functionality thereof.

(2) Starting materials with a viscosity within a wide range can be used.

(3) A fine pattern can be formed even on structures with a low resistance to pressure and impacts.

(4) Even when irregularities are present on the substrate surface, a fine pattern of a functional material can be formed on a specific portion.

(5) By using this method, a catalyst can be formed in a thermoelectric gas sensor or thermoelectric power generating element using power generation by a catalytic reaction of a combustible gas and a catalyst material.

(6) A catalyst with excellent performance can be directly formed as a fine pattern. Therefore, the catalytic performance of a portion of element can be greatly increased.

(7) The temperature at which the catalytic reaction is actively carried out is equal to or less than room temperature and heating for activating the catalytic reaction is unnecessary.

(8) A composite of metal ultrafine particles of a nanometer size can be patterned by mixing a metal chloride and an oxide powder with an organic dispersion medium and conducting heat treatment.

(9) Furthermore, by employing a fine pattern on a thermal insulating structure such as a membrane, heat generation by the catalyst in a gas sensor element or thermoelectric generator can be increased to a maximum.

(10) Therefore, a combustible gas can be easily detected in a gas detection concentration rate of from 1 ppm or less to 5% or more.

(11) By integrally employing the resistor pattern formation that enables coating in a state with controlled crystallinity and/or microstructure in a micro gas sensor element structure such as a membrane, the characteristics of the resistor material are utilized, thereby a sensor element with a high gas response rate even in low-temperature operation can be obtained.

### BRIEF DESCRIPTION OF THE DRAWINGS

FIG. 1 is a cross-sectional view of a micro thermoelectric gas sensor;

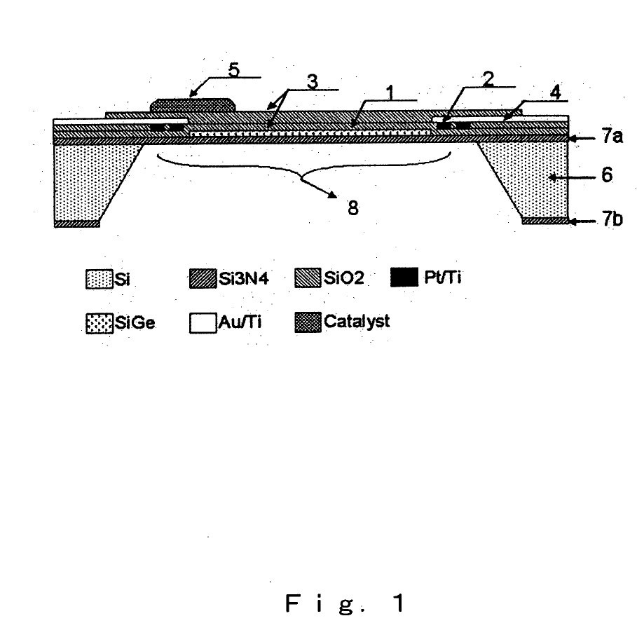

FIG. 2 is a cross-sectional view of a micro thermoelectric gas sensor with two membranes;

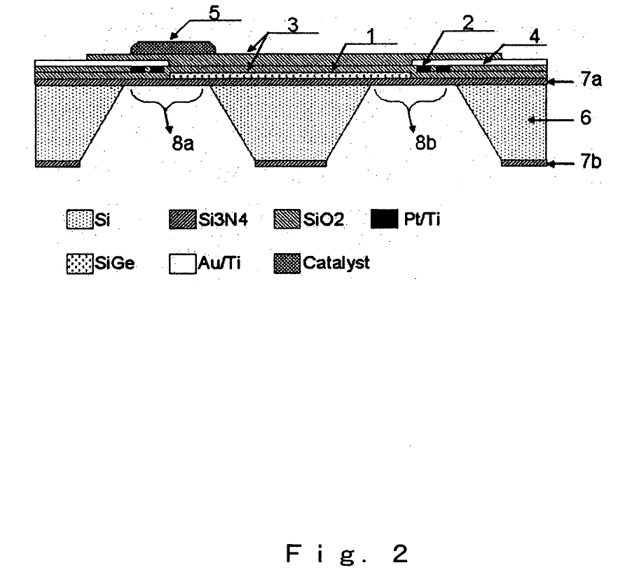

FIG. 3 is a top view of a micro thermoelectric gas sensor;

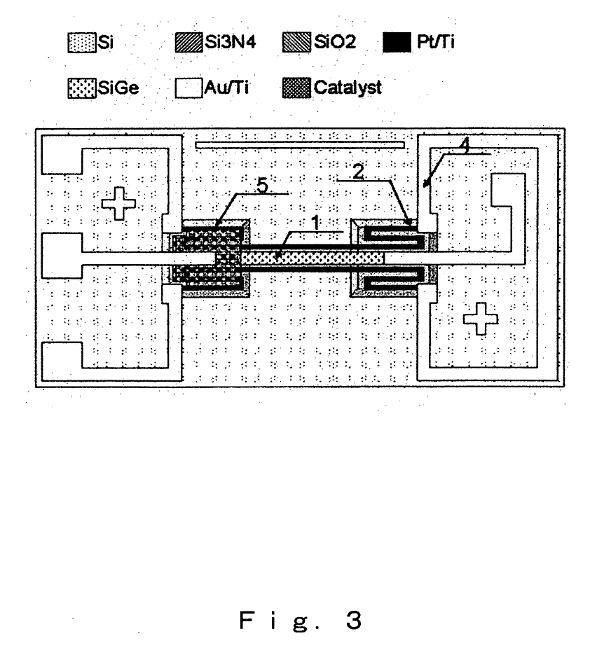

FIG. 4 is a response characteristic of a thermoelectric hydrogen sensor formed on an alumina substrate to a hydrogen concentration of 1% at room temperature of 25° C.; a) shows a voltage signal Vs and a temperature difference ΔT between the high-temperature section and low-temperature section; b) shows the variation of temperature in the high-temperature section and low-temperature section;

FIG. 5 is a response characteristic of a micro thermoelectric gas sensor to a 100 ccm flow of an air gas mixture containing 1% hydrogen when the microheater temperature is set to 100° C. A generated voltage signal is plotted against the left axis, and the variation of the temperature difference between the high-temperature section and low-temperature section is plotted for the same time at the right axis;

FIG. 6 shows the difference in response characteristics of a micro thermoelectric gas sensor (left) and a thermoelectric gas sensor (right) formed on an alumina substrate;

FIG. 7 illustrates the temperature dependence of a combustible gas response characteristic of a micro thermoelectric gas sensor using a thin-film platinum catalyst produced by sputtering;

FIG. 8 is an image drawing of pattern formation on a valley bottom of a non-flat surface having irregularities;

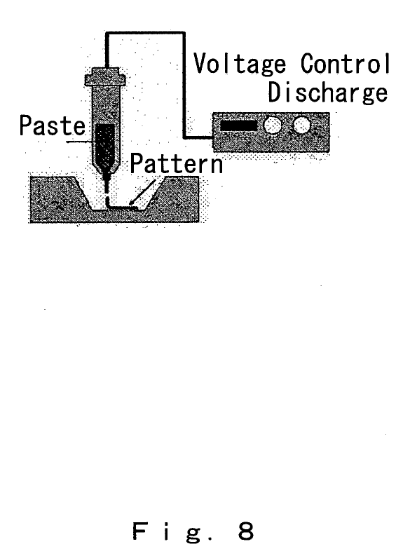

FIG. 9 shows the structure of a micro catalyst thermoelectric power generating element;

FIG. 10 is a top view of the micro catalyst thermoelectric power generating element;

FIG. 11 is a cross-sectional view of a micro thermoelectric gas sensor;

FIG. 12 shows a response characteristic of a micro thermoelectric gas sensor using a platinum catalyst produced by sputter deposition within a range from room temperature to 120° C.;

FIG. 13 shows a response characteristic of a micro thermoelectric gas sensor using a catalyst formed with a dispenser at room temperature;

FIG. 14 shows a response characteristic of a micro thermoelectric gas sensor element using a catalyst formed with a dispenser. A stable output can be obtained even with a combustible gas with a very low concentration;

FIG. 15 shows a power generating characteristic of a micro catalyst thermoelectric power generating element using a catalyst formed with a dispenser. A strong dependence of a gas response (combustion) characteristic is obtained by controlling the catalyst shape with high accuracy. In the left characteristic, the coating accuracy is poor and the shape is nonuniform, in the right characteristic, a shape close to an optimum structure was formed; and

FIG. 16 shows a response characteristic of a micro gas sensor using a semiconductor formed with a dispenser.

### EXPLANATION OF SYMBOLS

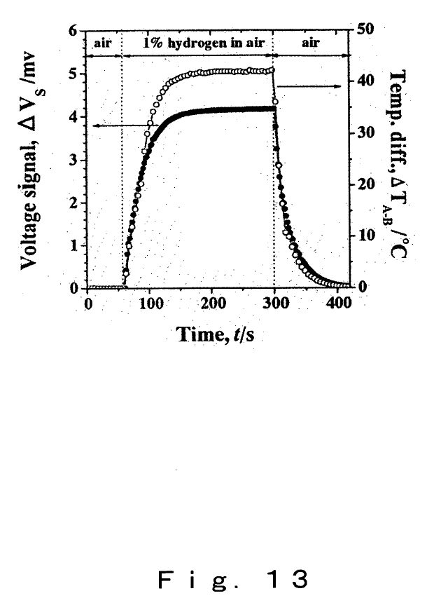

FIGS. 13

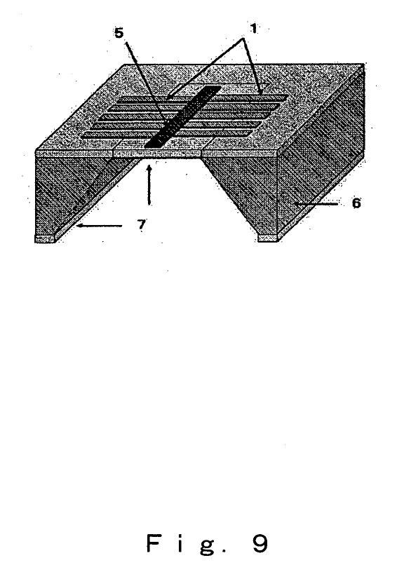

1 Thermoelectric conversion material film
2 Heater
3 Insulating film
4 Electrodes•Wiring
5 Catalyst
6 Silicon substrate
7
7a, 7b Nitride•Oxide multi-layered film
8a, 8b Membrane
   (FIGS. 9-11)
1 Thermoelectric conversion material film
2 Heater
3 Insulating film
4 Electrodes•Wiring
5 Catalytic pattern
6 Silicon substrate
7a Nitride•Oxide multi-layered film
7b Nitride•Oxide multi-layered film
8 Membrane

### BEST MODE FOR CARRYING OUT THE INVENTION

The first aspect for carrying out the present invention will be described below based on embodiments thereof, but the present invention is not limited to the below-described embodiments.

### Embodiment 1

A specific feature of the micro thermoelectric sensor in accordance with the present invention that greatly differs in structure from the general micro gas sensors is that the microheater structure and thermoelectric thin film are formed at the same time. Because a membrane formed to provide for thermal shielding cracks easily from a level of 1 mm², a large membrane is very difficult to produce. Accordingly, in the present embodiment, a micro thermoelectric hydrogen sensor was produced by fabricating a heater pattern, a thermoelectric pattern, and electrodes therefor within this surface area.

(1) Substrate

Because anisotropic etching of silicon is used in the fabrication of a microsensor, it is important to select appropriately the substrate and produce a film for etching stop. In the present embodiment, an oxide film and a nitride film were formed on a silicon substrate with a (100) plane and a thickness of about 300 μm. The oxide film was a thermal oxidation film grown under wet conditions at a temperature of 1000° C.; the film thickness was 80 nm. The nitride film was grown by a LPCVD method to a thickness of 250 nm at a reaction temperature of 800° C. Taking into account that the multilayer films will eventually serve as membranes, the aforementioned conditions were selected to minimize thermal stresses.

Prior to vapor depositing a thermoelectric thin film of SiGe, a silicon oxide film was formed over the entire upper surface of the substrate by a PECVD method. The film thickness of the oxide was 250 nm. The film thickness was confirmed with an ellipsometer, and then confirmed by observing the fracture surface an electron microscope.

(2) Thermoelectric Film Sputter Deposition

First, 1% phosphorus or boron was mixed with a SiGe alloy (Si 80%, Ge 20%) and the mixture was then ground to a mean particle size of no more than several microns in a planetary ball mill and molded. Then, a sintered body was produced by sintering (hot pressing method) for 5 h at 1000° C. The sintered body was used as a target for sputtering. A film of a thermoelectric conversion material of a SiGe system was then deposited by using this target and a high-frequency (RF) sputtering apparatus. The sputtering conditions were as follows: deposition pressure about 1.7×10⁻¹ Pa and sputtering output 150 W. The sputter deposition was conducted for 60 min and a film with a thickness of about 0.3 μm was formed. The film thickness was confirmed with an ellipsometer, and then found by direct observations of the fracture surface with an electron microscope.

(3) Formation of Insulating Film and Heat Treatment

An oxide film with a thickness of about 300 nm was vapor deposited by using PECVD to insulate the sputter deposited SiGe thin film and a platinum heater. With a plasma CVD method, a starting material gas was supplied into a chamber (a TEOS starting material was used to produce silicon oxide in this case), plasma was generated by applying a high-frequency voltage between electrodes, a substance generated by inducing a chemical reaction was deposited on the substrate, and a film was grown.

The sample was then introduced into a furnace with argon atmosphere and heat treatment was conducted for about 5 h at 900° C. to produce an oxide film and SiGe thin film with improved crystallinity. Part of the oxide film was thereafter removed by etching and zones (termed “windows”) for contact with electrodes were formed. The window pattern was formed by using photolithography.

(4) Formation of Platinum Heater Thin Film

A platinum heater was produced by a lift-off method and a sputter deposition method. Lift-off processing is used for patterning thin films that are difficult or impossible to etch. The lift-off processing is a method by which an inverse patter of a target patter is formed on a substrate from a metal or photoresist, a target thin film is vapor deposited, the unnecessary portions are thereafter removed together with the metal and photoresist, and a target pattern is left. First, an inverse pattern was fabricated from a photoresist, titanium (60 nm) and platinum (250 nm) were vapor deposited by sputter vapor deposition, and portions outside the pattern were removed with a remover.

(5) Formation of Insulating Film and Opening of Windows

An oxide film with a thickness of about 300 nm was vapor deposited by using PECVD to insulate the SiGe thin film, platinum heater, wiring metal, and catalyst. Furthermore, windows were formed by removing parts of the oxide film by dry etching. Reactive ion etching (RIE etching) was used for dry etching. RIE etching is a technology by which a high-frequency power is applied to a gas introduced into a device to obtained a plasma state and positive ions generated in the plasma are accelerated to bombard a substrate and enhance an etching reaction (physicochemical milling). With this method, if the gas pressure is several Pa (several tens of mTorr) or less, the movement direction of ions is arranged and the processing can be conducted in the desired milling direction (perpendicular to the substrate). Such process is called anisotropic etching and is a method indispensable for micro processing of semiconductors.

In principle, in order to induce an etching phenomenon, the product obtained by the reaction of the milling object and gas has to be a volatile substance. A compound comprising a halogen such as fluorine and chlorine that easily reacts with the substrate material and readily produces a volatile substance was used for the introduced gas. A CHF₃ gas and a CH₄ gas were used for etching the oxide. The oxide film was etched by RIE etching under the following conditions: CHF₃=30 ccm, CF₄=80 cam, pressure=6 Pa, and RF power=100 W.

For example, when a below-described nitride film was etched, a CH₄ gas was introduced and F (atoms) was produced by plasma excitation. Accordingly, a reaction was used by which a nitride film (solid) was reacted with F, producing a gas comprising SiF₄ and the like that was removed. A gold pattern for electrodes and metal wiring was produced by a lift-off method and sputter deposition method. First, an inverse pattern was produced from a photoresist, then titanium and gold were vapor deposited to a thickness of 60 nm and 300 nm, respectively, by sputter deposition, and the portions other than the pattern were then removed with a remover.

(6) Wet Etching

Part of the pattern of the nitride film on the lower surface of the substrate was removed to enable wet etching after the removal of the nitride film. This is also termed “wet etching mask”. The pattern was produced by photolithography, and the removal of the nitride film was conducted by a RIE etching method. The RIE etching was conducted under the following conditions: CF₄=80 ccm, pressure=6 Pa, and RF power=100 W. The places that were not protected with the nitride and were not wished to be subjected to etching, for example, the edges and upper surface of the substrate, were protected by applying wax and then wet etching was conducted by immersing the substrate into a 50% KOH aqueous solution. The silicon substrate was etched for about 5 h under a condition of solution temperature of 80° C. After the etching rate has been estimated, the etching was conducted for the prescribed interval, and the substrate was then removed from the solution and washed with distilled water.

(7) Sputter Deposition of Catalyst Thin Film

A catalyst thin film was formed by sputter deposition on part of the element surface subjected to the above-described processing. In order to form a thin film as a pattern, sputter deposition was conducted by placing a metal mask on the element. A platinum catalyst was used as the catalyst material to detect hydrogen. A catalyst film was produced by sputter deposition for 3 min at a sputter power of 100 W and a vapor deposition pressure of about 2×10⁻¹ Pa in a high-frequency (RF) sputter apparatus using a platinum target. A thermoelectric gas sensor was thus produced.

### Embodiment 2

A gas response characteristic of the micro gas sensor was tested.

(1) Thermal Insulation by Membrane or Microheater

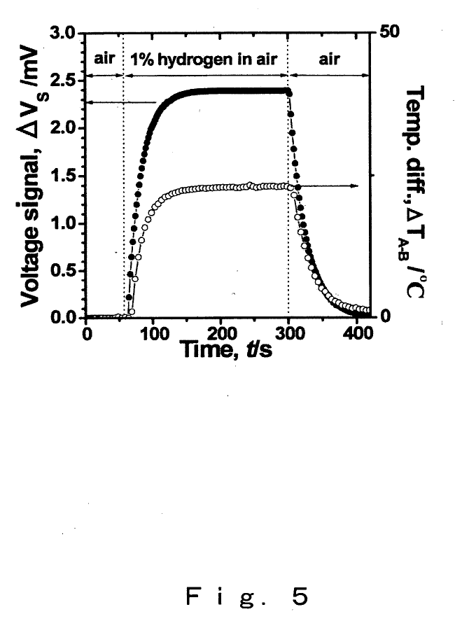

FIG. 5 shows a response characteristic to a 100 ccm flow of an air mixture gas containing 1% hydrogen when a microheater of a micro thermoelectric gas sensor was heated to 1001C. A generated voltage signal is plotted against the left axis, and the variations of temperature difference in a high-temperature portion and a low-temperature portion are plotted simultaneously against the right axis. By contrast when the film was formed on an alumina substrate, power consumption could be greatly reduced, and the consumed power was 50 mW at 100° C. for two membranes and 25 mW or less at 100° C. for one membrane element. Such low power consumption is due to excellent thermal insulation provided by the membrane structure and is a representative merit of the present microelement.

(2) Increase in Sensitivity

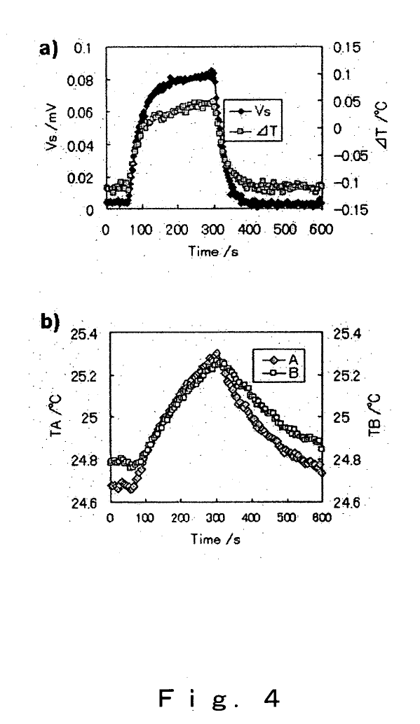

Owing to the thermal insulation effect, it was possible not only to decrease electric power consumption, but also to improve greatly the sensitivity of the sensor element. Because a catalyst with a low thermal capacity could be formed on a membrane with poor heat transfer, the effect of catalyst temperature increase by combustion heat of gas in the catalyst increased dramatically. The temperature difference in the sensor with an alumina substrate does not reach 1° C. in the case of the same gas comprising 1% hydrogen (the temperature difference is 0.15° C. as shown in FIG. 4), whereas in the case of the microelement, the temperature difference is about 24° C. (right ordinate in FIG. 5). The catalyst size was about 1 mm² that is about 1/70 that of the alumina substrate (8.5×8.5 mm²=72.25 mm²), but the temperature difference was increased dramatically by a factor of 24/0.15=160. Because the thermoelectric conversion performance is a physical constant of the thin-film material, this highly efficient generation of temperature difference directly becomes an increase in sensitivity.

(3) High-Speed Response

The response characteristic shown in FIG. 4 or FIG. 5 represents data obtained when a gas mixture of hydrogen and air flowed through a test chamber at a constant flow rate of 100 ccm, but response rate measurements in the units of seconds are difficult with this method. Because the microsensor has a minimized thermal capacity, a response of less than a second can be anticipated with respect to the target gas. Accordingly, to confirm this performance, the following test was conducted. A sensor covered and sealed with a rubber film was introduced into a box with a capacity of 30 L, hydrogen was introduced into the box with a capacity of 30 L to obtain the air mixture with a hydrogen content of 1% and then a fan was rotated. After rotating the fan for more than 3 min, the rubber film was ruptured and the sensor was exposed to a hydrogen gas mixture. In 4 min, the lid of the 30 L box was completely opened and the atmosphere inside the box was substituted with air. With this method the gas concentration can be changed instantaneously which is impossible in the flow system.

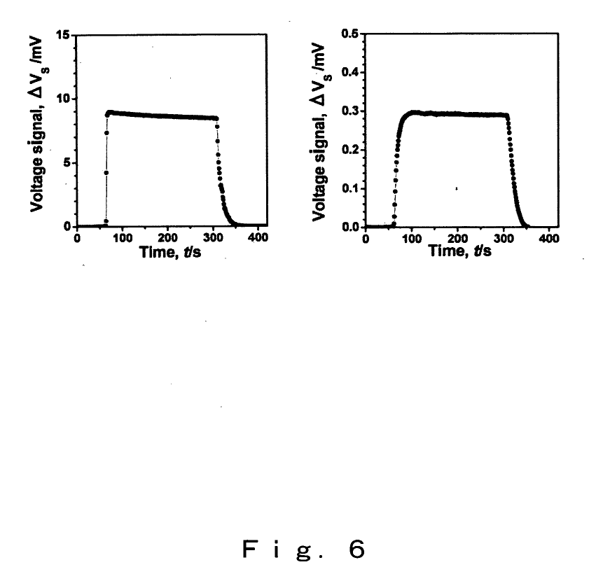

The above-described test was performed with respect to a micro thermoelectric gas sensor (on the left) and a thermoelectric gas sensor formed on an alumina substrate (on the right), and FIG. 6 shows the difference between the response characteristics of the two sensors. About 3 sec was necessary for the micro sensor to reach a 90% level, this time being about 20 sec faster than that of the sensor on the aluminum substrate.

(4) Hydrogen Selectivity

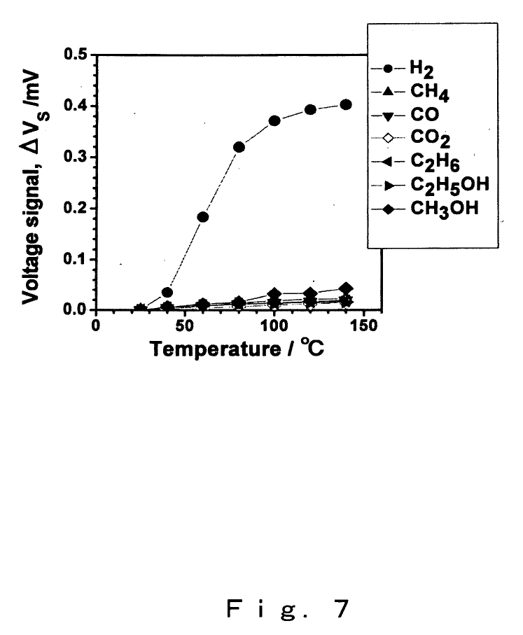

FIG. 7 shows the temperature dependence of a combustible gas response characteristic of a micro thermoelectric gas sensor using a thin-film platinum catalyst produced by a sputtering method. The sensor showed excellent hydrogen selectivity on par with the conventional devices at a temperature close to room temperature, while demonstrating high sensitivity and high-speed response.

The second aspect for carrying out the present invention will be described below based on an embodiment thereof, but the present invention is not limited to the below-described embodiment.

### Embodiment 3

In the present embodiment, pastes with various microstructures were produced and micropatterns of a catalyst were formed on a substrate by using a dispenser, as a preparatory test for finding a material for a paste to be used as a starting material for a functional material and for studying the relationship between the microstructure and the catalytic characteristic thereof.

(1) Preparation of Catalyst Powder and Paste Material

An aqueous solution of commercial platinum chloride and palladium chloride was prepared, immediately mixed with an oxide powder, and dried by heating to prepare a catalyst powder serving as a source starting material. The powder was mixed with a vehicle produced from terpineol and ethyl cellulose to prepare a paste-like functional material.

(2) Micropattern Formation with Dispenser

A catalyst was applied by using a dispenser to a predetermined position of an element and heated for 1 h at 300° C. to produce a catalyst. The catalyst was formed as a round pattern with a diameter of about 0.5 to 2.0 mm or a square pattern with a width of 0.5 to 1.5 mm.

The size of the pattern is limited by the inner diameter of the discharge nozzle, but in actual pattern formation, the size greatly depends on various parameters such as a discharged quantity, discharge pressure, and distance to the substrate. When a paste is coated with a dispenser, the higher is the air pressure, the more vigorous is the paste discharge. Therefore, a thick line can be obtained and the end point becomes thicker. In order to apply thin lines that are more preferred, for example, when a paste source material with a viscosity of about 3000 cP is used, it was found that the activity of paste discharge can be somewhat suppressed with an air pressure of 0.05 MPa or less and a micro pattern can be formed by applying a paste in a configuration in which the distance between a substrate onto which the paste is coated and the tip of the injection needle was 0.03 mm or less.

(3) Pattern Formation by Printing

Furthermore, for comparison and also to evaluate the catalytic characteristic, a catalyst pattern was produced by printing the same paste on a silicon substrate and the heat emission characteristic thereof was studied. Thus, a catalyst paste was printed on a silicon substrate and a thick catalyst film was produced by sintering for 1 h at 400° C. The performance of this ceramic catalyst and a commercial noble metal catalyst paste was compared. Both pastes were printed on a silicon substrate with a printing machine. Furthermore, with a commercial platinum catalyst, a platinum phase containing no frit consisting of glass components was studied. For example, by firing TR707 (manufactured by Tanaka Kikinzoku Kogyo) at 1200° C., a porous film could be formed and such film was suitable for gas sensors, fuel cells, and the like.

The printed ceramic catalyst and the catalyst produced by sputter deposition demonstrated almost identical heat emission characteristics at a temperature of 100° C. or higher, but at 50° C. or lower, the amount of heat emitted by the catalyst produced by sputter deposition decreased greatly and practically no heat was emitted at a temperature close to room temperature. By contrast, the ceramic catalyst efficiently induced a catalytic reaction even at a temperature close to room temperature and the heat emission characteristic was also good. In the case of ceramic catalyst, heat emission was equal to or more than half that at 100° C., and this was also affected by thermal conductivity to the substrate.

### Embodiment 4

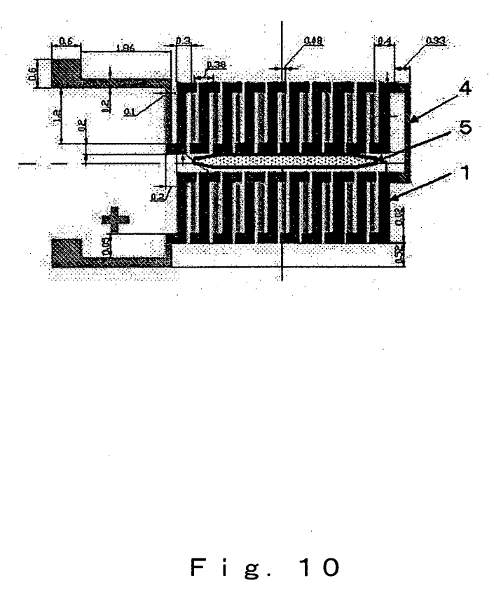

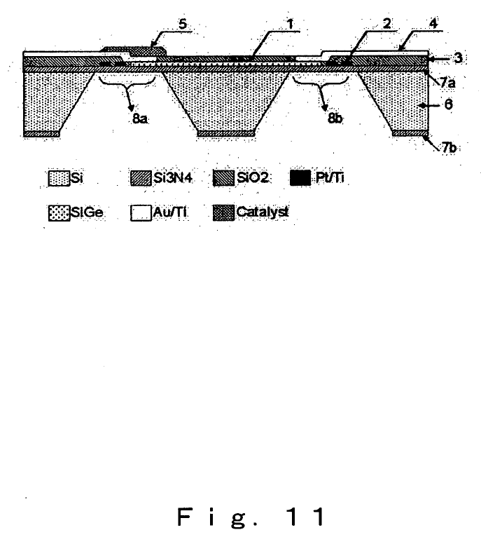

A microelement was produced by forming a catalyst micropattern by using a dispenser on a membrane with a low thermal conductivity so that the thermal energy emitted from the catalyst was not transferred to the peripheral zones in a thermoelectric power generating element and a thermoelectric gas sensor element. The thermoelectric power generating element and thermoelectric gas sensor element having a membrane structure are shown in FIG. 9, FIG. 10, and FIG. 11. The thermoelectric power generating element does not have a microheater structure, but is basically identical to the sensor element shown in FIG. 11 and manufactured by the same process.

The thermoelectric power generating element shown in FIG. 9 and FIG. 10 is a thermopile comprising thermocouples connected in series, such design raising the voltage and increasing the power generation efficiency. As described in detail in the previous patent application by the present inventors (Japanese Patent Application No. 2004-075982), the process for fabricating a micro thermoelectric gas sensor basically comprises a step of forming a membrane for heat shielding on a substrate and a step of forming a thermoelectric conversion material film pattern, a heater pattern, a wiring pattern, and a catalytic material pattern on the membrane.

### Embodiment 5

In the present embodiment a gas response characteristic of the gas detection sensors produced in Embodiment 3 and Embodiment 4 was studied. The gas mixture flow rate was 100 mL/min. An air gas mixture comprising hydrogen was used as a detection gas. The gas mixture flow was started at 60 sec. and the air started flowing at 300 sec. when the gas flowed above the element, the catalyst temperature started rising, at the same time the heat current flowed from a high-temperature section to a low-temperature section, a temperature gradient occurred, the difference in temperature became constant after a certain period has elapsed, and a stable DC voltage was outputted.

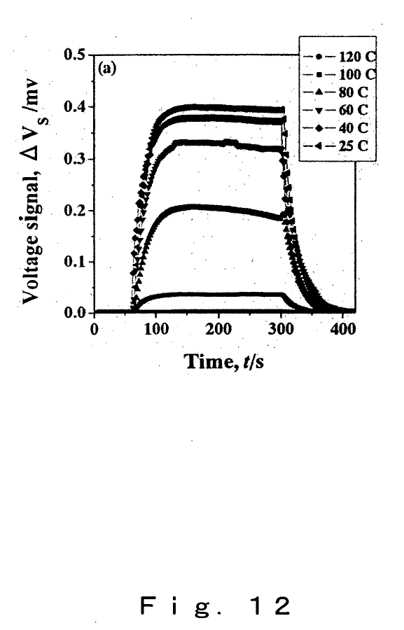

For comparison, FIG. 12 shows a response characteristic from room temperature to 120° C. of a micro thermoelectric gas sensor using a platinum catalyst produced by a sputter deposition process. The following problems are associated with the process of vapor depositing a thin-film catalyst on a membrane by using a metal mask. Thus, the process efficiency is low, a high voltage cannot be obtained because the increase in temperature is not large and, therefore, the difference in temperature decreases, as shown in the figure, and the catalyst has to be heated to a temperature close to 100° C., in particular, at a low temperature close to room temperature, in order to maintain a stable catalytic combustion characteristic because the catalytic activity is low.

FIG. 13 shows a response characteristic at room temperature of a micro thermoelectric gas sensor using a catalyst formed with a dispenser. At a temperature of 25° C., which is close to room temperature, an increase in temperature of about 40° C. or more has occurred and could be measured as a temperature difference on the element. Furthermore, a signal obtained by thermoelectric conversion of this temperature difference into a voltage signal could be confirmed as an output voltage.

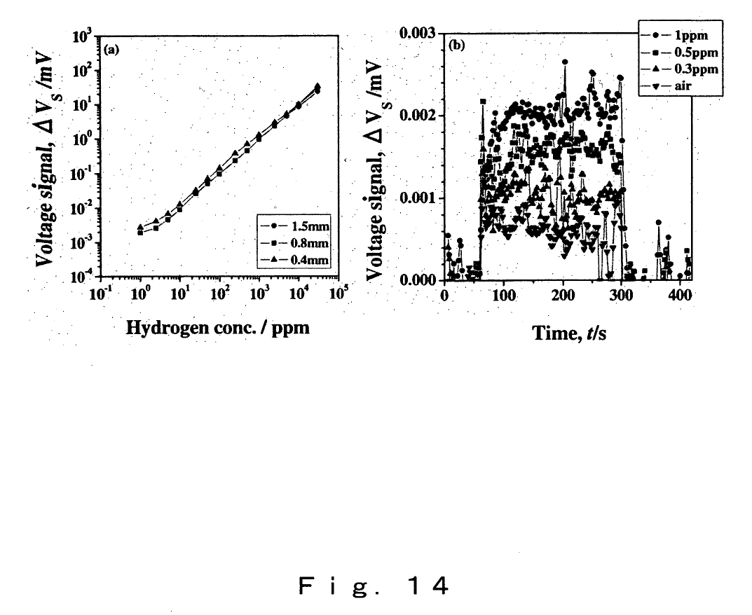

FIG. 14 shows the relationship between hydrogen concentration and signal voltage of a microelement using a catalyst formed with a dispenser. The operating temperature was set to 100° C. in order to avoid the effect of moisture, etc., present in the atmosphere. The gas concentration and output voltage demonstrated a linear relationship, and the concentration within a wide range of five orders of magnitude, from a low concentration of 0.5 ppm or less to a high concentration of 5% or more, could be detected with a high accuracy.

### Embodiment 6

FIGS. 9-10 show a thermoelectric power generating element in which a catalyst is formed on a membrane with a low thermal conductivity so as to prevent the heat energy generated from the catalyst from being transferred to the ambient medium, and power is generated by thermoelectric conversion using the temperature difference therebetween. In this embodiment a power generation characteristic of a micro thermoelectric power generating element in which a catalyst pattern was formed by using a disperser was studied.

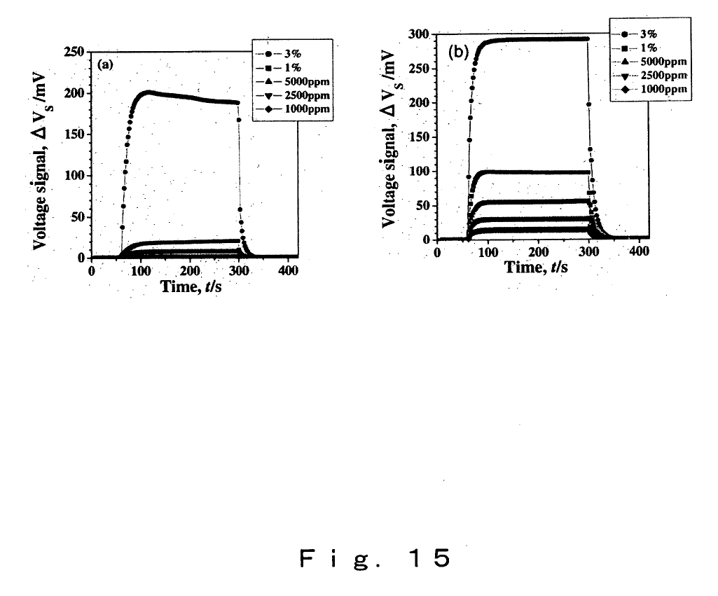

FIG. 15 shows a power generation characteristic at room temperature of a micro catalyst thermoelectric power generating element using a catalyst formed with a dispenser. A strong dependence of the gas response (combustion) characteristic is obtained by controlling the catalyst shape with high accuracy. The characteristic in the left figure is obtained with a low coating accuracy and a nonuniform shape, and that in the right figure is obtained when the shape close to an optimum structure was formed.

It is important that the temperature difference be maximized by forming the catalyst pattern only on the membrane, but the characteristic obtained changes significantly depending on the shape accuracy. As shown in FIG. 15, the linear formation of voltage caused by heat generation changes significantly depending on the catalyst shape. The element with a catalyst pattern formed with a high accuracy (right figure) makes it possible to obtain a stable voltage even at a lower fuel gas concentration.

The gas mixture flow rate was evaluated at 100 or 200 mL/min. An air gas mixture containing hydrogen at a hydrogen concentration of 1% and 3% was used as the detection gas. As shown in FIG. 14, the flow of gas mixture was actuated at 60 sec at room temperature, the flow was switched to air at 300 sec, and the response characteristic was studied. A stable reaction was obtained starting even from room temperature. In the case of a thermoelectric power generating element, using a catalyst formed with a pattern with a dispenser makes it possible to generate power with a high catalyst activity at a low temperature and with good efficiency even without heating.

In the conventional reported power generating elements, a catalytic reaction is induced by heating the catalyst with a heater (for example, Schaevitz, S. B., et al., “A MEMS Theromoelectric Generator”, in Proc. 11th International Conference on Solid State Sensors and Actuators Transducers, 01/Eutrosensors XV, Vol, 1, 30-33, edited by Obermeier, E., Springer, Munich, Germany, 2001). In accordance with the present invention, employing a pattern formation technology by which a catalyst material having an optimized catalytic characteristic is directly patterned with a dispenser enables a high degree of integration on a microelement, thereby making it possible to produce a micro power generating element which does not require a heating mechanism and in which a catalytic reaction can be sufficiently induced even at room temperature.

Table 1 shows the results obtained in evaluating the amount of generated power at a catalyst gas mixture flow rate of 100, 200 ccm and a hydrogen concentration of 1%, 3% in a generator in which a fine pattern of a catalyst is formed on the rear surface (lower surface) and front surface (upper surface) of a membrane by using a dispenser. The element shown in FIG. 10 was used. A highest generated power of about 0.33 μW was obtained from the element at a hydrogen concentration of 3% and a flow rate of 200 ccm.

TABLE 1
Power generation characteristic of a micro thermoelectric power generating element

| | | | | Catalyst | | |
|---|---|---|---|---|---|---|
| | | Resist- | Electromotive | temperature | Temperature | Generated |
| | H2/Air | ance/ | force | increase | difference | power |
| | flow | kΩ | ΔV_{S}/mV | ΔT_{A}/C | ΔT_{A-B}/C | P/nW |
| Rear | 1% 100 ccm | 67.8 | 15.020 | 9.17 | 8.170 | 0.832 |
| surface | | | | | | |
| | 3% 200 ccm | 67.7 | 117.850 | 31.13 | 17.000 | 51.287 |
| Front | 1% 100 ccm | 79.9 | 13.370 | 4.31 | 3.210 | 0.559 |
| surface | | | | | | |
| | 1% 200 ccm | 79.9 | 21.540 | 7.23 | 5.570 | 1.452 |
| | 3% 200 ccm | 30.8 | 201.00 | 38.35 | 20.730 | 327.9 |

### Embodiment 7

A semiconductor material was formed with a dispenser to activate the performance of the material and it was employed as a gas detection material of a micro gas sensor. The semiconductor material was a commercial tin oxide powder (Aldrich Tin Oxide nanopowder 54967-25G). The powder was suitable for a combustible gas because it was in the form of a nanosize fine particles and had high crystallinity.

(1) Paste Preparation

A paste-like functional material was prepared by mixing the powder with a vehicle produced from terpineol and ethyl cellulose. When the viscosity was high, for example about 10,000 cPs at a powder:vehicle ratio of 1:4, ethanol was added to adjust the viscosity. Thus, the viscosity was reduced to 3000 cps by adding 5% ethanol. The viscosity was reduced to about 1000 cps by adding 10% ethanol.

(2) Integration on a Microsensor

A thermoelectric microsensor produced without a SiGe process was used as a sensor platform. A tin oxide microelement was produced by coating a tin oxide paste in place of a SiGe pattern between two platinum lines by using a dispenser.

(3) Gas Response Characteristic Evaluation

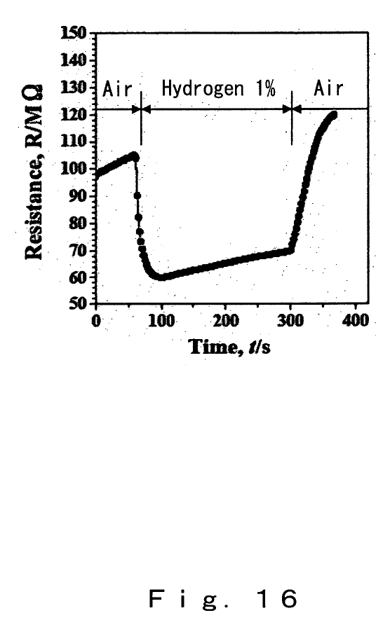

The resistance variation of the tin oxide pattern was evaluated by switching the flows of air and 1% hydrogen/air, while heating the semiconductor pattern with a microheater. The results shown in FIG. 16 were obtained under heating at 100° C. The sensitivity with respect to hydrogen gas (resistance variation) was almost identical to that of an undoped tin oxide ceramic sensor. However, a high response rate even at a low temperature of 100° C. was a characteristic superior to that of the usual ceramic sensor. In particular, the recovery time was remarkably improved from 1 h for the usual ceramic sensor to about 1 min.

### INDUSTRIAL APPLICABILITY

As described hereinabove, the present invention relates to a thermoelectric gas sensor with a microelement configuration, and a thermoelectric gas sensor with a microelement configuration can be provided by the present invention. In the thermoelectric gas sensor in accordance with the present invention, the catalyst temperature can be finely controlled with a microheater. Therefore, gas selectivity can be provided to the catalyst itself. The present invention can provide a gas sensor in which selectivity is further increased with a simple element. Furthermore, the present invention makes it possible to realize concentration measurements with a high-speed response and high sensitivity by forming the high-temperature section and low-temperature section of a thermoelectric thin film on the same membrane.

Furthermore, the present invention also relates to a method for forming a fine pattern for producing with a dispenser a fine pattern of a material to be reacted with a combustible gas. According to the present invention, starting materials with a viscosity within a wide range can be used and a fine pattern can be formed even on a structure with a low resistance to pressure and impacts. Because a fine pattern of a functional material can be formed on a specific portion even when irregularities are present on the substrate surface, this method can be used to form a catalyst of a thermoelectric gas sensor or a thermoelectric power generating element that can use the heat generated by a catalytic reaction of a combustible gas and a catalyst material. The catalytic performance of a portion of the element can be greatly increased by directly forming a catalyst with excellent performance as a fine pattern. A novel gas sensor element or thermoelectric generator can be provided in which the temperature at which the catalytic reaction can be actively carried out is equal to or less than room temperature and heating for activating the catalytic reaction is unnecessary.

1. A micro thermoelectric gas sensor comprising:
a membrane for heat shielding formed on a substrate,
a catalyst material that induces a catalytic reaction in contact with a gas to be detected, a thermoelectric conversion material film that converts a local temperature difference produced by heat generation caused by the reaction into a voltage signal, and a microheater for temperature control for facilitating stable gas detection of the gas sensor formed, which are on the membrane, and
a high-temperature section and a low-temperature section of a thermoelectric thin film formed on the same membrane.

2. The thermoelectric gas sensor according to claim 1, wherein the thermoelectric conversion material film is a segment of a thermocouple having a high-temperature section and a low-temperature section.

3. The thermoelectric gas sensor according to claim 1, wherein the thermoelectric conversion material film is a thermocouple having a high-temperature section and a low-temperature section, a plurality of the thermocouples are provided, and the plurality of thermocouples are connected in serial.

4. The thermoelectric gas sensor according to any one of claims 1 through 3, wherein a membrane with a thickness of 1 μm or less is obtained by wet etching a rear surface of the substrate.

5. The thermoelectric gas sensor according to claim 4, wherein a plurality of membranes are provided on the substrate.

6. The thermoelectric gas sensor according to any one of claims 1 through 5, wherein an insulating film is formed in a state of contact with the membrane on the membrane, a bonding film is formed on the insulating film in a state of contact with the insulating film and a heater for serving to bond the insulating film and the heater, and a catalytic material layer is formed in thermal contact with said heater being electrically insulated by the insulating film.

7. The thermoelectric gas sensor according to claim 1, wherein after a thermoelectric conversion material film pattern has been produced, the pattern is heat treated at a high temperature to improve crystallinity thereof.

8. The thermoelectric gas sensor according to any one of claims 1 through 7, wherein a SiGe thin film is formed as the thermoelectric conversion material film.

9. A method for producing a micro thermoelectric gas sensor, comprising the steps of:
forming a membrane for heat shielding on a substrate, forming a thermoelectric conversion material film pattern on the membrane, forming a heater pattern thereafter, forming an insulation layer of an oxide film; opening a window for an electrode contact section and then forming a wiring pattern, and wet etching the rear surface of the substrate.

10. A method for forming a micropattern of a catalyst or a resistor on a substrate of a gas sensor or a thermoelectric power generator, comprising the steps of:
(1) designing and preparing a functional material serving as a starting material for a catalyst or a resistor by controlling the predetermined microstructure thereof, (2) applying the functional material serving as a starting material for a catalyst or a resistor to a predetermined position on a substrate according to a predetermined pattern by discharging, while moving a dispenser three-dimensionally, and (3) thereby forming a micropattern in a state where the predetermined microstructure of the functional material remains controlled.

11. The method for forming a micropattern according to claim 10, wherein a viscosity of the starting material is within a range of from 0.001 to 100 Pa·s.

12. The method for forming a micropattern according to claim 10, wherein the micropattern is formed on the substrate by discharging the material under controlled impacts and without mutual contact in a relative arrangement of the substrate and a nozzle tip of a discharge section of the dispenser.

13. The method for forming a micropattern according to claim 10, wherein the functional material is applied to a specific portion of a groove bottom of the substrate that has irregularities in the substrate surface shape by adjusting the relative arrangement of the substrate and a nozzle tip of a discharge section of the dispenser.

14. A gas sensor element, having a catalyst material formed by (1) designing and preparing a functional material serving as a starting material for a catalyst or a resistor by controlling the predetermined microstructure thereof, (2) applying the functional material serving as a starting material for a catalyst or a resistor to a predetermined position on a substrate according to a predetermined pattern by discharging, while moving a dispenser three-dimensionally, and (3) thereby forming a micropattern in a state where the predetermined microstructure of the functional material remains controlled.

15. A thermoelectric power generator, having a heat generating section formed by (1) designing and preparing a functional material serving as a starting material for a catalyst or a resistor by controlling the predetermined microstructure thereof, (2) applying the functional material serving as a starting material for the catalyst or resistor to a predetermined position on a substrate according to a predetermined pattern by discharging, while moving a dispenser three-dimensionally, and (3) thereby forming a micropattern in a state where the predetermined microstructure of the functional material remains controlled.

16. The gas sensor element according to claim 14, wherein a temperature at which a catalytic reaction proceeds actively is reduced to room temperature or below and heating for activating the catalytic reaction is made unnecessary by forming a micropattern in a state where a predetermined microstructure including the shape and distribution state of particles that are the main components of the functional material including an oxide and a catalyst remains controlled.

17. The thermoelectric power generator according to claim 15, wherein a temperature at which a catalytic reaction proceeds actively is reduced to room temperature or below and heating for activating the catalytic reaction is made unnecessary by forming a micropattern in a state where a predetermined microstructure including the shape and distribution state of particles that are the main components of the functional material including an oxide and a catalyst remains controlled.

18. The method for forming a micropattern according to claim 10, wherein when preparing a catalyst powder or catalyst paste for use in said micropattern, a metal chloride and an oxide powder is mixed with an organic dispersion material and heat treatment is conducted at a temperature from 150° C. to 300° C., Or a pattern of a composite of nanometer metal ultrafine particles is formed by mixing an oxide powder and a metal with a nanometer particle size.

19. The gas sensor element according to claim 14, wherein the heat generation of a catalyst can be raised to a maximum level by employing, in a thermal insulating structure such as a membrane, the catalyst pattern formation that enables the application in a state in which said microstructure remains controlled.

20. The thermoelectric power generator according to claim 15, wherein the heat generation of a catalyst can be raised to a maximum level by employing, in a thermal insulating structure such as a membrane, the catalyst pattern formation that enables the application in a state in which said microstructure remains controlled.

21. The gas sensor element according to claim 16, wherein a combustion gas with a detectable gas concentration range from 1 ppm and below to 5% or more can be detected by using a thermoelectric conversion principle in said gas sensor element.

22. The method for forming a micropattern according to claim 10, wherein properties of a resistor material are used to increase a gas response rate in low-temperature operation by integrally employing, in a microelement structure such as a membrane, the resistor pattern formation that enables the application in a state in which crystallinity and microstructure remain controlled.

23. A gas sensor element, characterized in that a micropattern of a catalyst material or a resistor is formed in a predetermined position on a substrate in a state where a predetermined microstructure thereof remains being controlled.

24. A thermoelectric power generator, characterized in that a micropattern of a catalyst material or a resistor is formed in a predetermined position on a substrate in a state where a predetermined microstructure thereof remains being controlled.
